(19) United States
(12) Patent Application Publication
(10) Pub. No.: US 2026/0023182 A1
(43) Pub. Date: Jan. 22, 2026

(54) MANAGING DIGITAL PROCESSING FOR BEAMFORMING FOR OPTICAL PHASED ARRAYS

(71) Applicant: Analog Photonics LLC, Boston, MA (US)

(72) Inventors: Michael J. Nickerson, Boston, MA (US); Michael Robert Watts, Hingham, MA (US)

(73) Assignee: Analog Photonics LLC, Boston, MA (US)

(21) Appl. No.: 19/242,115

(22) Filed: Jun. 18, 2025

Related U.S. Application Data
(60) Provisional application No. 63/673,006, filed on Jul. 18, 2024.

(51) Int. Cl. G01S 17/26; G01S 7/4914; G01S 7/493; G01S 17/89

(52) U.S. Cl. CPC G01S 17/26; G01S 7/4914; G01S 7/493; G01S 17/89

(57) ABSTRACT

In one aspect, in general, an apparatus comprises: an optical receiver configured to receive optical waves over a receive aperture that comprises a plurality of sub-apertures coupled to different respective detectors, where each detector is configured to produce a digital signal based at least in part on a received optical wave; and circuitry configured to apply one or more phase shifts to a respective digital signal from each detector of the optical receiver where the one or more phase shifts are applied based at least in part on a first beam pattern that includes a plurality of intensity peaks at different respective angular positions, and determine respective amplitudes of optical waves corresponding to two or more angular positions of the first beam pattern based at least in part on the one or more phase shifts.

### CROSS-REFERENCE TO RELATED APPLICATION(S)

This application claims the benefit of and priority to U.S. Provisional Application Ser. No. 63/673,006, entitled “MANAGING DIGITAL PROCESSING FOR BEAMFORMING FOR OPTICAL PHASED ARRAYS,” filed Jul. 18, 2024, which is incorporated herein by reference.

### TECHNICAL FIELD

This disclosure relates to managing digital processing for beamforming for optical phased arrays.

### BACKGROUND

Some optical systems, i.e., optical communication systems or light detection and ranging (LiDAR) systems, can be configured to transmit optical waves and receive optical waves. Some systems can optimize various aspects of a configuration based on different criteria. In some optical communication systems, optical waves can be transmitted from optical sources and collected by receivers. Some optical communication systems can be configured as free space optical communication systems wherein optical waves propagate through air or space between a transmitter or receiver. In some LiDAR systems, an optical wave is transmitted from an optical source to target object(s) at a given distance and the light reflected from the target object(s) is collected.

In some examples, a system can transmit or receive light using optical phased arrays (OPAs). Some OPAs used in such systems have a linear distribution of emitter elements (also called emitters or antennas). Steering about a first axis perpendicular to the linear distribution can be provided by changing the relative phase shifts in phase shifters feeding each of the emitter elements. Other techniques can be used for steering about a second axis orthogonal to the first axis. The optical source used in such a system is typically a laser, which provides an optical wave that has as narrow linewidth and has a peak wavelength that falls in a particular range (e.g., between about 100 nm to about 1 mm, or some subrange thereof), also referred to herein as simply “light.”

### SUMMARY

In one aspect, in general, an apparatus comprises: an optical receiver configured to receive optical waves over a receive aperture that comprises a plurality of sub-apertures coupled to different respective detectors, where each detector is configured to produce a digital signal based at least in part on a received optical wave; and circuitry configured to apply one or more phase shifts to a respective digital signal from each detector of the optical receiver where the one or more phase shifts are applied based at least in part on a first beam pattern that includes a plurality of intensity peaks at different respective angular positions, and determine respective amplitudes of optical waves corresponding to two or more angular positions of the first beam pattern based at least in part on the one or more phase shifts.

Aspects can include one or more of the following features.

The apparatus further comprises: an optical source providing a source optical wave; and an optical transmitter coupled to the optical source and configured to transmit an optical beam according to a second beam pattern that includes a plurality of intensity peaks at different respective angular positions; wherein each detector of the optical receiver comprises an optical input port configured to receive a local oscillator optical wave that is coherent with the source optical wave.

Each detector of a respective sub-aperture of the plurality of sub-apertures is configured to determine phase or amplitude information based at least in part on a portion of the local oscillator optical wave and a portion of an optical wave received at the respective sub-aperture.

The optical waves received by the optical receiver comprise a portion of the optical beam transmitted by the optical transmitter that is reflected by a target region.

The circuitry is further configured to perform light detection and ranging (LiDAR) on the optical waves reflected by the target region to estimate a distance to a portion of the target region.

The one or more phase shifts are based at least in part on the different respective angular positions of the plurality of intensity peaks of the optical beam.

Each angular position of the first beam pattern corresponds to a respective angular position of the second beam pattern.

The circuitry is further configured to determine respective amplitudes of optical waves corresponding to each angular position of the first beam pattern.

The optical transmitter comprises an optical phased array.

The optical phased array of the optical transmitter comprises a plurality of antenna elements and a plurality of phase shifters, where each antenna element of the plurality of antenna elements is coupled to a respective phase shifter of the plurality of phase shifters.

The optical transmitter is configured to transmit the optical beam according to the second beam pattern based at least in part on phase shifts applied by each phase shifter of the plurality of phase shifters to optical waves propagating in the optical phased array.

Each detector comprises an in-phase/quadrature-phase (IQ) detector.

Each sub-aperture of the plurality of sub-apertures of the optical receiver comprises a respective optical phased array.

Each optical phased array of the plurality of sub-apertures comprises a respective plurality of antenna elements and a respective plurality of phase shifters, where each antenna element of a respective plurality of antenna elements is coupled to a respective phase shifter of a respective plurality of antenna elements.

The optical receiver receives optical waves comprising a portion of an optical beam transmitted by an optical transmitter, where the portion of the optical beam comprises an encoded message.

The circuitry is further configured to decode the encoded message based at least in part on the optical waves received by the optical receiver.

The optical receiver is connected to a control module that is configured to decode the encoded message based at least in part on the optical waves received by the optical receiver.

In another aspect, in general, a method comprises: receiving optical waves with a receive aperture comprising a plurality of sub-apertures coupled to different respective detectors that are configured to produce respective digital signals based at least in part on the optical waves; applying one or more phase shifts to respective portions of each digital signal produced by respective detectors of two or more sub-apertures of the plurality of sub-apertures, where the one or more phase shifts are based at least in part on a first beam pattern that includes a plurality of intensity peaks at different respective angular positions; and determining respective amplitudes of received optical waves associated with two or more angular positions of the first beam pattern based at least in part on the one or more phase shifts and the respective portions of each digital signal produced by respective detectors of two or more sub-apertures of the plurality of sub-apertures.

Aspects can include one or more of the following features.

The method further comprises transmitting an optical beam, where the optical beam is associated with a second beam pattern comprising a plurality of intensity peaks at different respective angular positions.

The optical waves received by the receive aperture comprise a portion of the optical beam that is reflected by a target region.

Each detector comprises an optical input port configured to receive a local oscillator optical wave that is coherent with an optical wave of the optical beam.

At least a portion of the optical beam comprises an encoded message.

The method further comprises decoding the encoded message based at least in part on the optical waves received by the receive aperture.

The method further comprises determining respective amplitudes of received optical waves associated with each angular position of the first beam pattern based at least in part on the one or more phase shifts and the respective portions of each digital signal produced by respective detectors of two or more sub-apertures of the plurality of sub-apertures.

Each detector comprises a respective in-phase/quadrature-phase (IQ) detector.

Each sub-aperture of the plurality of sub-apertures comprises a respective optical phased array.

Aspects can have one or more of the following advantages.

In some implementations, the methods and techniques disclosed herein can be associated with increased field-of-view of a detection and ranging or communication system. In some implementations, a system can be configured to process light arriving from multiple angular positions in a field-of-view simultaneously, rather than scanning over light arriving from single angular positions. Some systems configured to process multiple angular positions can be associated with decreased data collection times relative to other systems.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. The plots resulting from numerical simulations, as indicated below, are prophetic examples of some of the techniques described herein.

FIGS. 1A-1C are schematic diagrams of example digital beamforming systems.

FIG. 2A is a schematic diagram of an example of a LiDAR system.

FIG. 2B is a schematic diagram of an example communication system.

FIG. 3 is a schematic diagram of an example of an optical phased array.

FIG. 4 is a schematic diagram of an example of a grating-antenna-based optical phased array.

FIGS. 5A-5B are schematic diagrams of examples of angular steering associated with radiation intensity patterns for optical phased arrays.

FIGS. 6A-6B are plots of numerical simulations associated with receivers of a beamforming system.

FIGS. 7A-7B are plots of numerical simulations associated with transmitters of a beamforming system.

FIGS. 8A-8B are plots of numerical simulations associated with configuring a beamforming system.

FIG. 9 depicts a flowchart of an example method of using a system.

### DETAILED DESCRIPTION

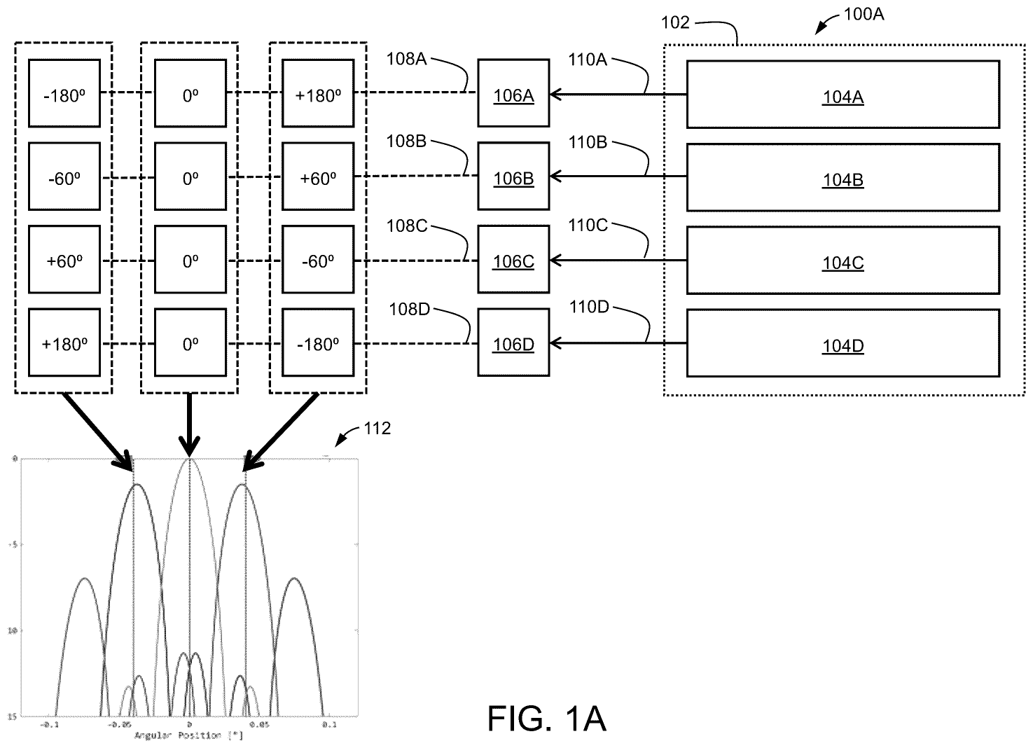

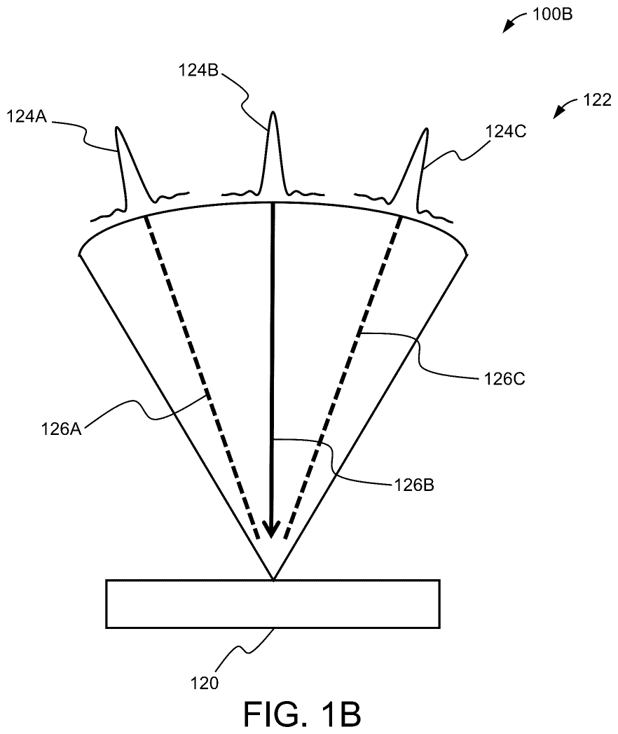

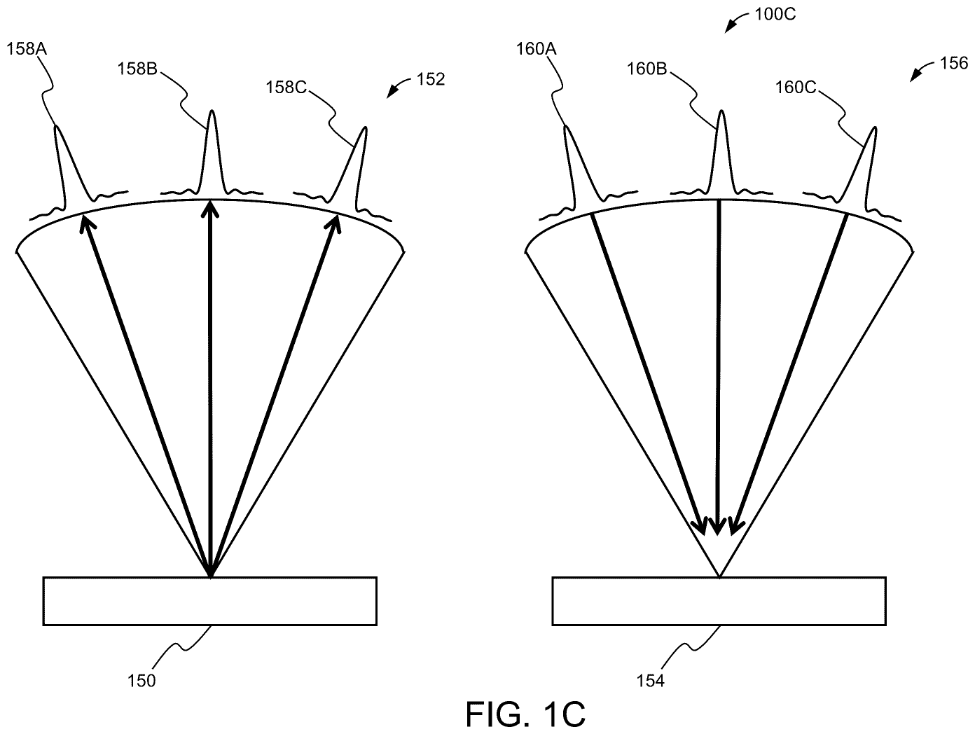

FIG. 1A depicts an example optical receiver 100A that can be included in a system configured for digital beamforming in which beam patterns for each digital combination of sub-apertures can be digitally processed in parallel. A system can be implemented in various configurations, including as a single apparatus or as a combination of one or more apparatuses that collectively perform the functions of a system. In some examples, the one or more apparatuses can form a device, i.e., a system-on-a-chip, or the one or more apparatuses can be separate devices. The optical receiver 100A comprises a receive aperture 102, sometimes referred to as an RX aperture. In this example, the receive aperture 102 comprises a plurality of sub-apertures 104A-104D, i.e., a sub-aperture 104A, a sub-aperture 104B, a sub-aperture 104C, and a sub-aperture 104D, that are coupled to different respective detectors 106A-106D, i.e., a detector 106A, a detector 106B, a detector 106C, and a detector 106D. In some examples, the detectors 106A-106D can each be configured as in-phase/quadrature-phase (IQ) detectors, as described in more detail below. Each detector 106A-106D is configured to produce different respective digital signals 108A-108D based at least in part on an optical signal 110A-110D provided by the respective sub-apertures 104A-104D that each collect optical waves arriving from various angles over a field-of-view. In other words, each of the sub-aperture 104A, the sub-aperture 104B, the sub-aperture 104C, and the sub-aperture 104D provide an optical wave 110A, an optical wave 110B, an optical wave 110C, and an optical wave 110D, respectively. One or more phase shifts are then applied to portions of each digital signal 108A-108D. In this example, phase shifts of −180°, 0°, and +180° are applied to respective portions of the digital signal 108A produced by the detector 106A and the digital signal 108D produced by the detector 106D. Phase shifts of −60°, 0°, and +60° are applied to respective portions of the digital signal 108B and the digital signal 108C produced by the detector 106B and the detector 106C, respectively. Respective amplitudes of optical waves received from different respective angular positions can then be determined based at least in part on the one or more phase shifts and the digital signals 108A-108D, as demonstrated by the plot 112 of numerical simulations shown in FIG. 1A. In this example, a coherent digital sum of the portions of the digital signals 108A-108D with respective applied phase shifts of +180°, +60°, −60°, and −180° degrees corresponds to a portion of the optical beam having an angular position of +0.04 degrees. In other words, this coherent digital sum corresponds to a portion of the optical beam received from an angle of +0.04 degrees. By way of example, when the applied phases are flipped in sign, i.e. each digital signal 108A-108D has a respective applied phase shift of −180°, −60°, +60°, and +180°, the optical receiver 100A can be used to determine that a portion of the optical beam is received from an angle of −0.04 degrees. The case with no phase shifts applied corresponds to the signal received from 0 degrees, which is the same signal that would be accessed via coherent optical combination in the case of a full RX aperture. As shown in FIG. 1A, by applying appropriate phase shifts on the digital signals 108A-108D (e.g., digital IQ signals) received from sub-apertures 104A-104D, signals associated with three angular positions in a field-of-view can be simultaneously processed by a system comprising the optical receiver 100A rather than one angular position in the field-of-view. The processing of the signals can be used to determine the amplitudes of optical waves received from a given angular position, where that amplitude can be quantified in any of a variety of ways. For example, the amplitude can be quantified as an intensity (i.e., proportional to an amplitude squared), or as an amount of optical power (i.e., an intensity collected over a given area). As described below in more detail, more parallelism is possible by applying more sophisticated phase patterns in multiple combinations.

In some examples, the phase shifts can be applied to each of the digital signals 108A-108D or portions thereof by circuitry. Some examples of circuitry can be implemented externally to a system. In some examples, the circuitry can make copies of each digital signal 108A-108D and apply a respective phase shift to each copy. For instance, circuitry can be configured to make a first copy, a second copy, and a third copy of the digital signal 108A and then apply a respective phase shift of −180°, 0°, and +180° to each of the first copy, the second copy, and the third copy. In some examples, the circuitry can also be configured to process the phase-shifted digital signals in order to determine an amplitude of a reflected optical wave associated with an intensity peak of the beam pattern having an angular position. In some examples, the circuitry can comprise a field programmable gate array (FPGA) or application-specific integrated circuit (ASIC).

FIG. 1B depicts an example system 100B, i.e., a communication system or a receiver of a LiDAR system, comprising a receive aperture 120 that is configured to receive optical waves. The receive aperture 120 is configured to process received optical waves based on an optical beam pattern 122 comprising far-field intensity peaks. In other words, the receive aperture 120 is divided into a plurality of sub-apertures and signals from the plurality of sub-apertures are processed as shown in FIG. 1A. In this example, the optical beam pattern 122 comprises intensity peak 124A, an intensity peak 124B, and an intensity peak 124C forming a plurality of intensity peaks 124A-124C. The intensity peak 124A is associated with an angular position 126A, the intensity peak 124B is associated with an angular position 126B, and the intensity peak 124C is associated with an angular position 126C. In other words, each intensity peak of the plurality of intensity peaks 124A-124C is associated with a different respective angular position of a plurality of angular positions 126A-126C. By configuring a receive aperture based on an optical beam pattern, a system can determine amplitudes of received optical waves associated with two or more angular positions. In this example, the receive aperture 120 receives an optical wave at the angular position 126B. In some examples this optical wave can be provided by a separate optical transmitter (not shown), i.e., as part of an optical communication system. By applying phase shifts to signals from a plurality of sub-apertures, the system 100B can be configured to determine an amplitude of the optical wave associated with the angular position 126B. The system 100B can also be configured to determine an amplitude of an optical wave associated with the angular position 126A and an amplitude of an optical wave associated with the angular position 126C. In this example, the amplitudes of optical waves associated with each of the angular position 126A and the angular position 126C can be zero or close to zero, since the receive aperture 120 is only receiving an optical wave at the angular position 126B. In other words, by configuring the receive aperture 120 based on the beam pattern, the system 100B is configured to simultaneously process multiple points in a field-of-view and determine from which angular position an optical wave is arriving.

In some examples, an optical transmitter (not shown) can send signals to an associated optical receiver. In other words, an optical transmitter can be separate from the associated optical receiver. In some examples, a receive aperture can receive optical waves from “background” optical sources, i.e., optical sources that are not an optical transmitter associated with the optical receiver.

In some examples, a system, i.e., a LiDAR system, can be configured to include an optical transmitter that is configured to transmit an optical beam according to a beam pattern that includes a plurality of intensity peaks at different respective angular positions such that an optical receiver can receive an optical beam. In some examples, the optical transmitter and the optical receiver can form a single device, i.e., an apparatus. FIG. 1C depicts a system 100C comprising a transmit aperture 150 that is configured to transmit an optical beam 152 and a receive aperture 154 that is configured to receive an optical beam 156, i.e., optical waves. The optical beam 152 is associated with a first beam pattern comprising a plurality of intensity peaks 158A-158C, i.e., an intensity peak 158A, an intensity peak 158B, and an intensity peak 158C, at different respective angular positions. Likewise, the optical beam 156 is associated with a second beam pattern comprising a plurality of intensity peaks 160A-160C, i.e., an intensity peak 160A, an intensity peak 160B, and an intensity peak 160C, at different respective angular positions. By dividing the receive aperture 154 into a plurality of sub-apertures and processing signals from the plurality of sub-apertures, as shown in FIG. 1A, the amplitudes of optical waves at angular positions associated with the beam pattern can be determined. In some examples, the optical beam 156 can comprise a portion of the optical beam 152 that is reflected by a target region. Each angular position of a respective intensity peak of the plurality of intensity peaks 158A-158C of the optical beam 152 can correspond to a different respective angular position of an intensity peak of the plurality of intensity peaks 160A-160C of the optical beam 156. In other words, each angular position of the first beam pattern corresponds to the respective angular position of the second beam pattern.

In a LiDAR system, some transmitted optical beams can interact with one or more objects in a target region. In some examples, a portion of an optical beam can be reflected by one or more objects of a target region. Some objects can have features that cause a portion of the optical beam to be scattered or backscattered to a system. For instance, some objects can be associated with a surface roughness that causes a scattering of the optical beam. In other words, some reflected optical waves that are received by the system can include light from a portion of a transmitted optical beam that has been scattered or backscattered from one or more objects.

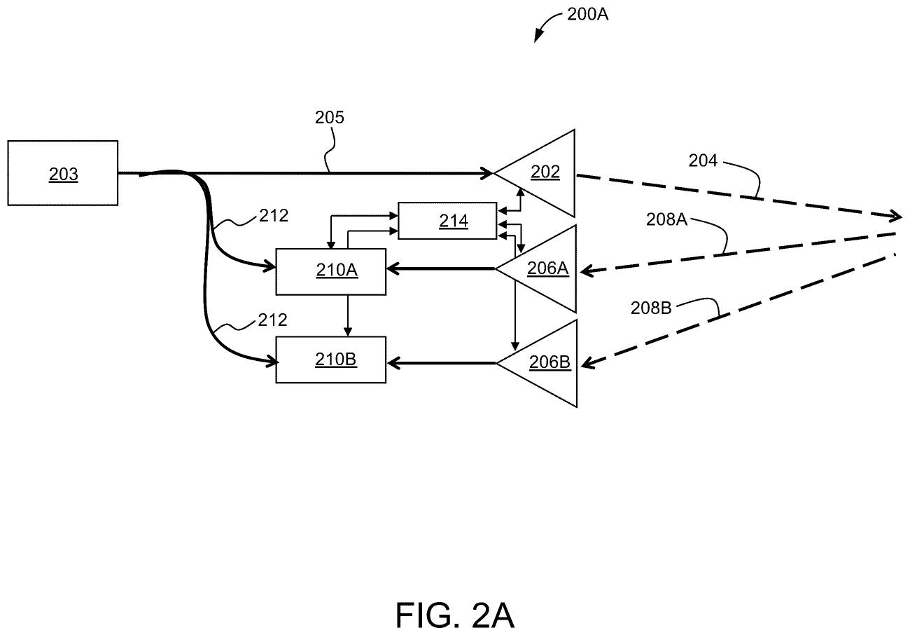

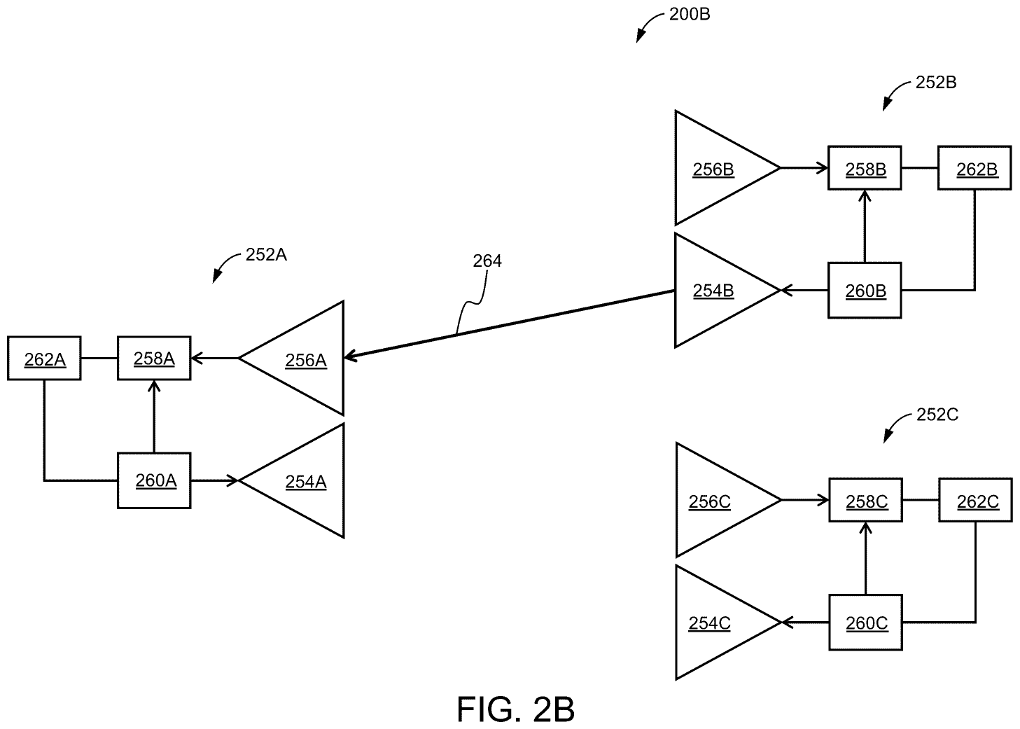

FIG. 2A shows an example of a system 200A in which some of the digital beamforming techniques shown in FIGS. 1A-1B can be used. In some examples, the system 200A can be integrated into a LiDAR system. The system 200A uses a configuration that can include one or more transmitter (Tx) antenna modules and one or more receiver (Rx) antenna modules. For example, some implementations are configured to use separate Tx and Rx antenna modules, where the separate antenna modules provide a separate transmitting aperture and receiving aperture (i.e., in a bistatic arrangement). In other implementations, an antenna module can be configured to operate in both a transmitter mode of operation and a receiver mode of operation (i.e., in a monostatic arrangement) where the transmitting aperture and the receiving aperture are the same. In the example of FIG. 2A, the system 200A includes a transmitter antenna module 202 that transmits an optical beam 204 at an angle that can be steered over a steering range. The system 200A further comprises a first receiver antenna module 206A and a second receiver antenna module 206B that can each be controlled to receive light incoming from a particular angle (i.e., a multi-static arrangement). For example, the first receiver antenna module 206A can be configured to receiving incoming light 208A including a portion of the optical beam 204 reflected from a target object or region, and the second receiver antenna module 206B can be configured to receive incoming light 208B including a portion of the optical beam 204 reflected from the target object or region. In some examples, the first receiver antenna module 206A and the second receiver antenna module 206B can be referred to as “sub-apertures.”

The system 200A includes an optical source 203 that provides an optical wave 205 to the transmitter antenna module 202. In some implementations, the optical source 203 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 203 is a frequency tunable laser system in which the frequency of the light provided can be swept to perform frequency modulated continuous wave (FMCW) LiDAR measurements. A first coherent receiver module 210A and a second coherent receiver module 210B receiving collected light from the first receiver antenna module 206A and the second receiver antenna module 206B, respectively, are configured to coherently mix the collected light with light or a portion of light of a local oscillator 212, sometimes abbreviated “LO”, which can be derived from the optical source 203 or from a portion of the optical wave 205 provided to the transmitter antenna module 202. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal. In other words, the first coherent receiver module 210A and the second coherent receiver module 210B can each comprise a photodetector or detector that is configured to receive, at an optical input port (not shown), a local oscillator optical wave that is coherent with an optical wave of the source. In other words, each detector can determine phase or amplitude information based at least in part on a portion of a local oscillator optical wave and a portion of an optical wave received at a respective sub-aperture. In some examples, one or more phases can be applied to the electrical signals from the output of the photodetection system.

A control module 214 is configured to control various aspects of the antenna modules and coherent receiver modules to determine information about a target object associated with a detection event based at least in part on one or more characteristics of the received reflected light. In addition to a location of a target object that has reflected light, there may also be range information characterizing a distance to the target object, and/or velocity information characterizing a relative speed of the target object, that can be obtained based at least in part on a frequency chirp (e.g., a linear chirp) that is applied to the optical wave 205 generated by the optical source 203. In other words, an optical wave relayed from a portion target region can be used to estimate a distance to the portion of the target region. The control module 214 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

FIG. 2B depicts an example of a system 200B configured as a free-space optical communication system. The system 200B comprises a first optical transceiver module 252A, a second optical transceiver module 252B, and a third optical transceiver module 252C. In other words, the system 200B comprises nodes configured for optical communication. The first optical transceiver module 252A comprises a transmitter antenna module 254A and a receiver antenna module 256A. A coherent receiver module 258A receives collected light from the receiver antenna module 256A and coherently mixes the collected light with light from an optical source 260A, i.e., a local oscillator. The optical source 260A is also configured to provide light to the transmitter antenna module 254A. A control module 262A is configured to control various aspects of the antenna modules and the coherent receiver module. The second optical transceiver module 252B comprises a transmitter antenna module 254B and a receiver antenna module 256B. A coherent receiver module 258B receives collected light from the receiver antenna module 256B and coherently mixes the collected light with light from an optical source 260B, i.e., a local oscillator. The optical source 260B is also configured to provide light to the transmitter antenna module 254B. A control module 262B is configured to control various aspects of the antenna modules and the coherent receiver module. The third optical transceiver module 252C comprises a transmitter antenna module 254C and a receiver antenna module 256C. A coherent receiver module 258C receives collected light from the receiver antenna module 256C and coherently mixes the collected light with light from an optical source 260C, i.e., a local oscillator. The optical source 260C is also configured to provide light to the transmitter antenna module 254C. A control module 262C is configured to control various aspects of the antenna modules and the coherent receiver module.

In this example, the receiver antenna module 256A of the first optical transceiver module 252A receives light 264 from the transmitter antenna module 254B of the second optical transceiver module 252B. In some examples, each of the control module 262A, the control module 262B, and the control module 262C can comprise circuitry configured to perform various functions. For instance, in some implementations, the circuitry of a control module can be configured to encode information or messages into optical waves or light to be transmitted to another optical transceiver module. In some examples, this encoding can comprise modulating an amplitude, a frequency, a polarization, a phase, or some combination thereof, of light produced by an optical source. Circuitry of a control module can also be configured to decode the information that is encoded in optical waves or light by demodulating the optical waves. Some optical communication systems can also include a central control module (not shown) in communication with each node such that the central control module can collectively control one or more of the nodes. In some optical communication systems, nodes, or optical signals from nodes, can move relative to other nodes in space and time. For instance, the first optical transceiver module 252A can be moving relative to the second optical transceiver module 252B. Alternatively, the second optical transceiver module 252B can be transmitting light over a range of angular positions, i.e., “scanning” an optical beam. In some implementations, using the methods and techniques disclosed herein, a receiver antenna module can be configured such that the receiver antenna module monitors multiple angular positions simultaneously. Such configurations can allow for an optical transceiver module to “lock on” to an optical signal from another optical transceiver module.

In some implementations, the first optical transceiver module 252A can receive an optical beam from the third optical transceiver module 252C while also receiving an optical beam from the second optical transceiver module 252B.

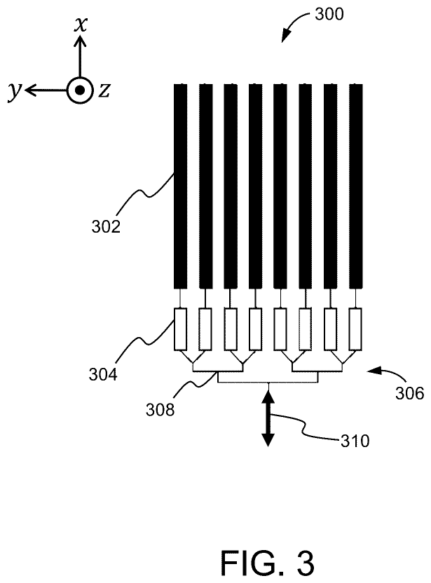

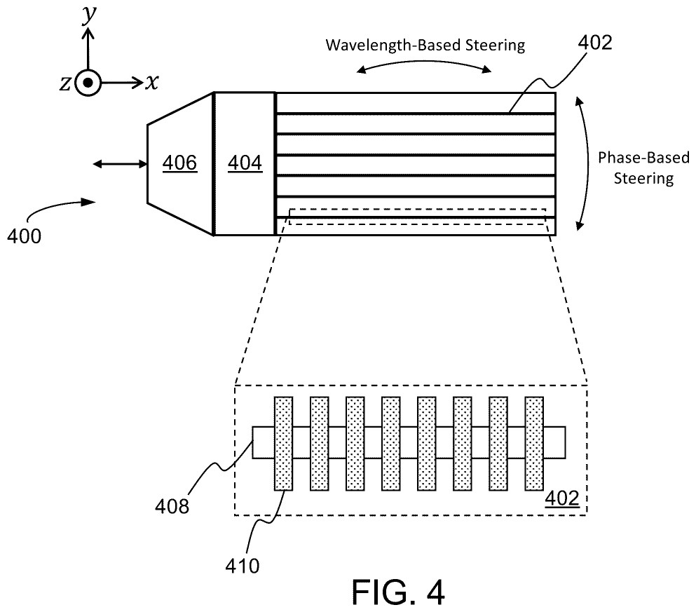

Any of a variety of techniques can be used to steer the transmission angle of an optical beam provided by a transmitter antenna module over a steering range and to steer the reception angle of a receiver antenna module, such as those shown in FIGS. 2A-2B. In some implementations, an OPA is used to enable steering of a lobe of a radiation intensity pattern (also referred to as a gain pattern) associated with the OPA. Some OPAs have a linear distribution of optical antennas. Steering about a first axis perpendicular to the linear distribution can be provided, for example, by changing the relative phase shifts in phase shifters coupled to each of the optical antennas. For example, FIG. 3 shows an example OPA 300 that includes an array of optical antennas 302. In this example, the optical antennas 302, sometimes referred to as “emitters” are distributed along the y-axis such that each optical antenna has a position on the y-axis. Light can be emitted from (and/or received into) optical antennas 302 from different emission planes depending on the type of optical antennas being used. For a grating-antenna-based OPA, each optical antenna is configured as an optical grating, as described in more detail in FIG. 4, and power from individual optical waves is emitted gradually over the length of the optical gratings over an emission plane in the plane of the page in FIG. 3 (the x-y plane). Alternatively, for an end-fire-antenna-based OPA, each optical antenna is configured to emit light from the ends of the optical antennas at an emission plane that is perpendicular to the plane of the page in FIG. 3 (the y-z plane). In either case, the optical waves optically interfere with each other starting at the emission plane to form an optical phased array output beam when the OPA 300 is used as a transmitter. The direction of peak constructive interference depends on the relative phase shifts imposed on light entering the optical antennas.

In some examples, a sub-aperture of a receive aperture can comprise an OPA such as the OPA 300 shown in FIG. 3. In some examples, an optical transmitter or transmit aperture can comprise an OPA such as the OPA 300 shown in FIG. 3.

The OPA 300 includes an array of optical phase shifters 304 that impose respective phase shifts on optical waves provided as phase shifted optical waves entering the respective optical antennas 302 when the OPA is used as a transmitter, or on optical waves that have been collected by respective optical antennas 302 when the OPA is used as a receiver. The optical phase shifters 304 can be, for example, electro-optic, thermal, liquid crystal, p-n junction phase shifters. In some examples, each of the optical phase shifters 304 is controlled independently, while in other examples two or more of the optical phase shifters 304 may be jointly controlled. An optical coupler 306 is configured to couple an optical port 310 to the array of optical phase shifters 304. In this example, the optical coupler 306 is in the form of a power splitting network formed from interconnected power splitters 308. In this example, the power splitters 308 are 1×2 power splitters (also referred to as 50/50 power splitters) and are interconnected by waveguides in a binary tree arrangement to achieve substantially equal power into each optical phase shifter 304 from an input optical wave entering the optical port 310 when the OPA 300 is used as a transmitter (Tx operation), and to provide substantially equal path lengths between each optical phase shifter 304 and the optical port 310. When the OPA 300 is used as a receiver (Rx operation), the light received by the optical antennas 302 and phase shifted by the optical phase shifters 304 is combined into an output optical wave at the optical port 310, which can then be further manipulated, transformed, or measured.

In some examples, the optical antennas 302 can be referred to as antenna elements. As shown in FIG. 3, the OPA 300 comprises a plurality of antenna elements, i.e., the optical antennas 302. Each antenna element of the plurality of antenna elements is connected to a respective optical phase shifter 304. In some examples, the optical phase shifters 304 can be referred to as a plurality of optical phase shifters. In other words, each antenna element of the plurality of antenna elements is connected to a respective optical phase shifter of a plurality of optical phase shifters. As shown in FIG. 3, each antenna element of the plurality of antenna elements, i.e., the optical antennas 302, is connected to a respective optical phase shifter of the plurality of optical phase shifters, i.e., the optical phase shifters 304, by an optical waveguiding structure, or a portion of an optical waveguiding structure.

FIG. 4 shows an example of a grating-antenna-based OPA 400 that is configured for phase-based steering about the x-axis and wavelength-based steering about the y-axis. In this example, the OPA 400 comprises a plurality of optical grating antennas, each optical grating antenna, i.e., an emitter, having a different position along the y-axis. For example, when configured for Tx operation, optical waves propagate along optical grating antennas 402 (along the x axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters in a phase shifter (PS) module 404 and the steering in the other angular direction being performed by wavelength of an optical wave distributing optical power via an optical coupler 406. The adjustment of the transmission angle for the Tx operation and collection angle for the Rx operation in the phase-controlled angular direction can be dynamically performed as the phases imposed by the phase shifters in the PS module 404 can be quickly tuned. Each optical grating antenna 402 is formed from a waveguide 408 and grating elements 410 arranged periodically along the waveguide 408 with a particular pitch p1 (e.g., a constant spacing between grating elements 410) to perturb the guided optical wave causing emission in the direction of the grating elements 410. The angle at which the light is emitted from each optical grating antenna 402 depends on a relationship between the pitch p1 and the wavelength, and thus can be steered by changing the wavelength.

The PS module 404 can also be configured to provide focusing. For example, the emitted light can have a nonlinear phase front imposed on it by the phase shifters in the PS module 404 for focusing in Tx operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an end-fire optical antenna is used.

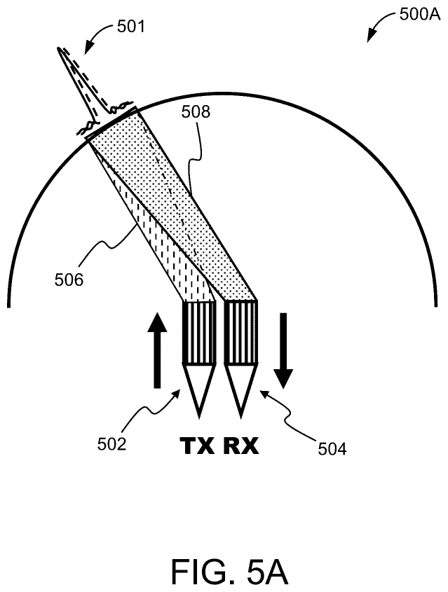

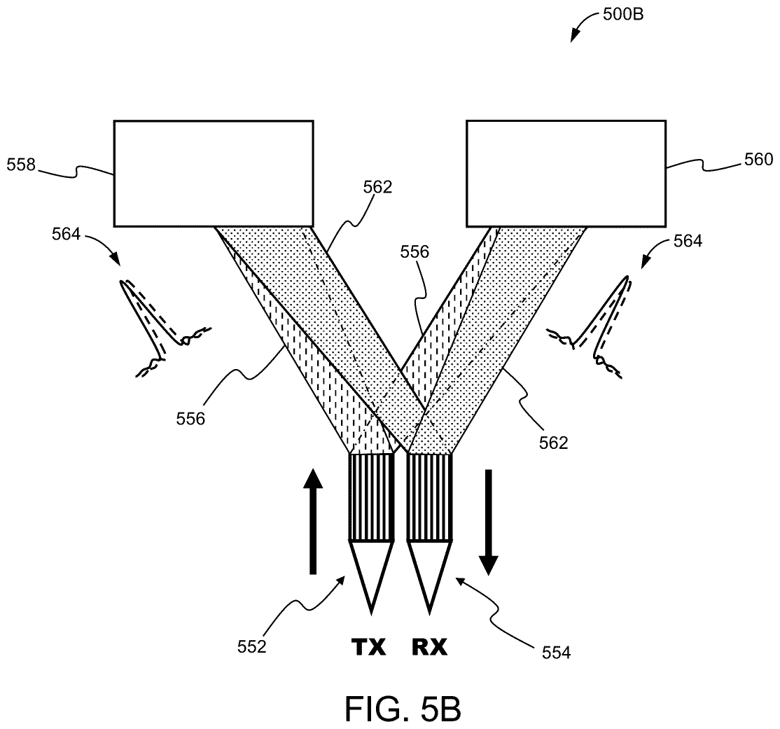

FIG. 5A shows an example system 500A, i.e., a transceiver of a LiDAR system, producing radiation intensity patterns 501 associated with a transmitter OPA 502 and a receiver OPA 504. In this example, main lobes associated with a transmitter radiation pattern 506 and a receiver radiation pattern 508 overlap. Such an arrangement of main lobe overlap can result, for example, from tuning phase shifters associated with transmitter and receiver optical antennas in the respective OPAs. Reflected light from a target object situated near the main lobes is received by the receiver OPA 504. In each radiation intensity pattern, there may be a main lobe and additional grating lobes that occur on each side of the main lobe due to the limit in how close adjacent optical antennas can be in an OPA, which may limit the phase-based angular tuning range. In some implementations, the examples described herein may be designed to operate over a predetermined range of optical wavelengths such as, for example, the λ=1500 to 1600 nm band or the λ=1270 to 1330 nm band, and the pitch p corresponding to a distance between adjacent optical antennas may be of similar magnitude to the optical wavelength to increase the spacing between grating lobes (and thereby increase tuning range), or in some cases less than half of the optical wavelength to avoid grating lobes. For example, for operation in the 1500 to 1600 nm band, 700 nm≤p≤4000 nm may be typical. In some examples, hundreds to thousands of optical antennas with these pitches can allow for the fabrication of devices with small physical footprints. By way of example, a device comprising one hundred optical antennas can be associated with a physical footprint of ˜70 μm to 400 μm. By way of example, a device comprising one thousand optical antennas can be associated with a physical footprint of ˜700 μm to ˜4000 μm, or ˜4 mm.

FIG. 5B depicts an example system 500B, i.e., a transceiver of a LiDAR system or a communication system. The system 500B comprises a transmitter OPA 552 and a receiver OPA 554. The transmitter OPA 552 produces a radiation pattern 556, i.e., a first beam pattern, comprising multiple intensity peaks. The radiation pattern 556 interacts with a first object 558 and a second object 560, i.e., objects in a target region. The receiver OPA 554 receives reflected light associated with a radiation pattern 562, i.e., a second beam pattern, comprising multiple intensity peaks. By way of example, intensity patterns 564 associated with each of the radiation pattern 556 and the radiation pattern 562 are also shown. In this example, main lobes associated with the radiation pattern 556 and the radiation pattern 562 overlap. Such an arrangement of main lobe overlap can result, for example, from tuning phase shifters associated with transmitter and receiver optical antennas in the respective OPAs. In some examples, using the methods and techniques disclosed herein, a system can be configured to simultaneously receive and process optical signals arriving from multiple angles or angular positions.

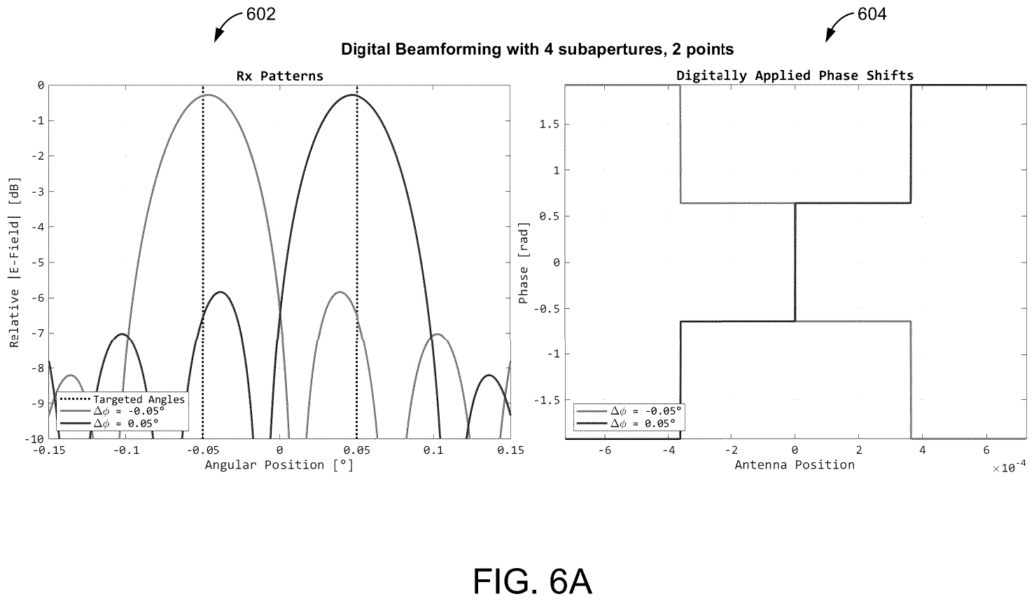

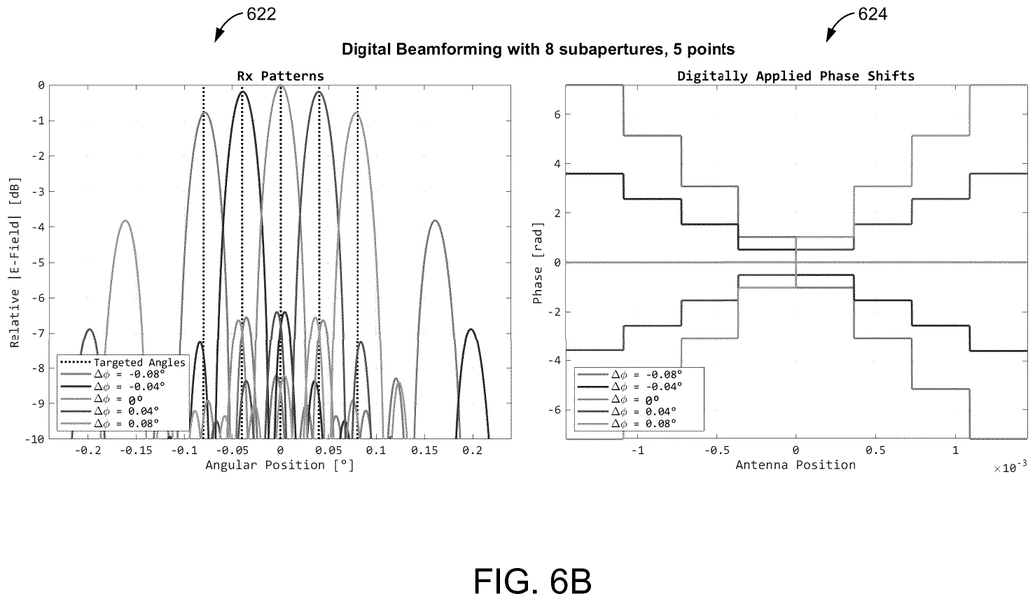

FIGS. 6A-6B, FIGS. 7A-7B, and FIGS. 8A-8B depict plots of numerical simulations associated with digital beamforming.

FIG. 6A depicts a plot 602 and a plot 604 of numerical simulations associated with digital beamforming using four sub-apertures, for example, using the system depicted in FIG. 1A. The plot 602 depicts the relative electric field of an optical beam, i.e., a received optical wave, associated with a beam pattern that includes a plurality of intensity peaks at different respective angular positions. In this example, the electric field, and therefore the intensity, peaks near angular positions of −0.05° and 0.05°. In some examples, these peaks can be referred to as “points” in a field-of-view. The plot 604 depicts phase shifts that can be digitally applied to each sub-aperture, where each sub-aperture is associated with a respective antenna position along an axis, as shown by the horizontal “steps.” As shown in FIG. 6A, by applying a respective phase shift to each sub-aperture of four sub-apertures, the beam pattern associated with the optical beam can be determined. In other words, amplitudes of optical waves associated with angular positions of the beam pattern can be determined.

Other combinations of sub-apertures and applied phase shifts can also be used to determine more complex beam patterns. FIG. 6B depicts a plot 622 and a plot 624 of numerical simulations associated with digital beamforming using eight sub-apertures. The plot 622 depicts the relative electric field of an optical beam, i.e., a receive optical beam, associated with a beam pattern that includes a plurality of intensity peaks at different respective angular positions. In this example, the electric field, and therefore the intensity, peaks near angular positions of −0.08°, −0.040, 00, 0.04°, and 0.08°. The plot 624 depicts phase shifts that can be digitally applied to each sub-aperture, where each sub-aperture is associated with a respective antenna position along an axis, as shown by the horizontal “steps.” As shown in FIG. 6B, by applying a respective phase shift to each sub-aperture of eight sub-apertures, the beam pattern associated with the optical beam, i.e., amplitudes of intensity peaks of the optical beam having angular positions, can be determined.

As shown in FIGS. 6A-6B, a system can be configured based on a beam pattern comprising an arbitrary number of angular positions. By tailoring the phase shifts applied to digital signals based on a beam pattern, a system can be configured to determine amplitudes of optical waves associated with angular positions of the beam pattern. In some examples, a number of sub-apertures of a system can be associated with a number of amplitudes associated with angular positions of a beam pattern that the system can measure. For instance, some systems with N sub-apertures can be configured to measure N I amplitudes associated with angular positions of a beam pattern. In some implementations, a number of amplitudes associated with angular positions of a beam pattern that a system can measure can be depend on factors including a distance between sub-apertures or a full-width at half maximum of peaks of a beam pattern.

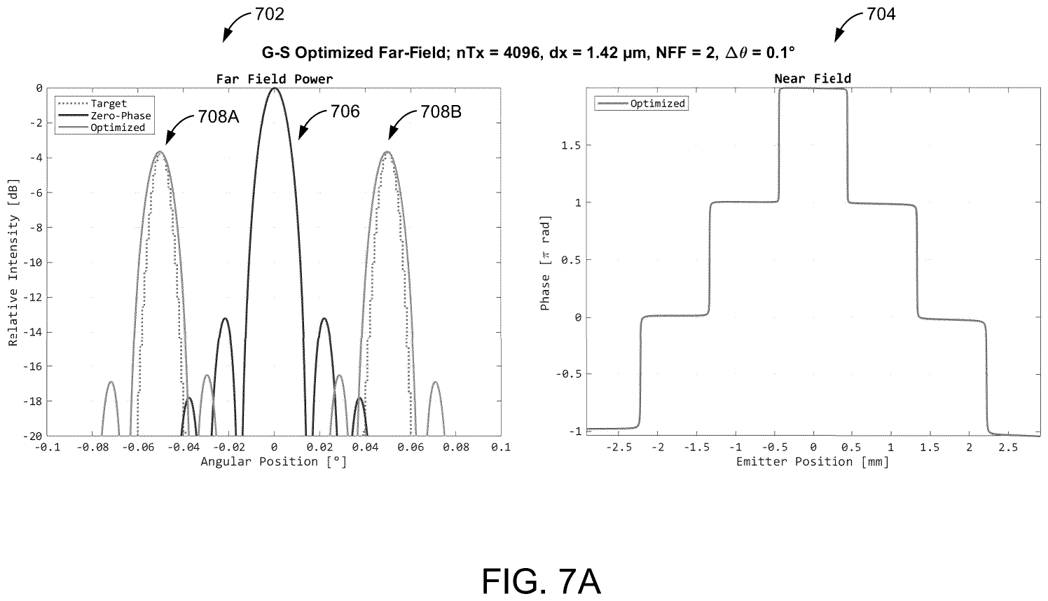

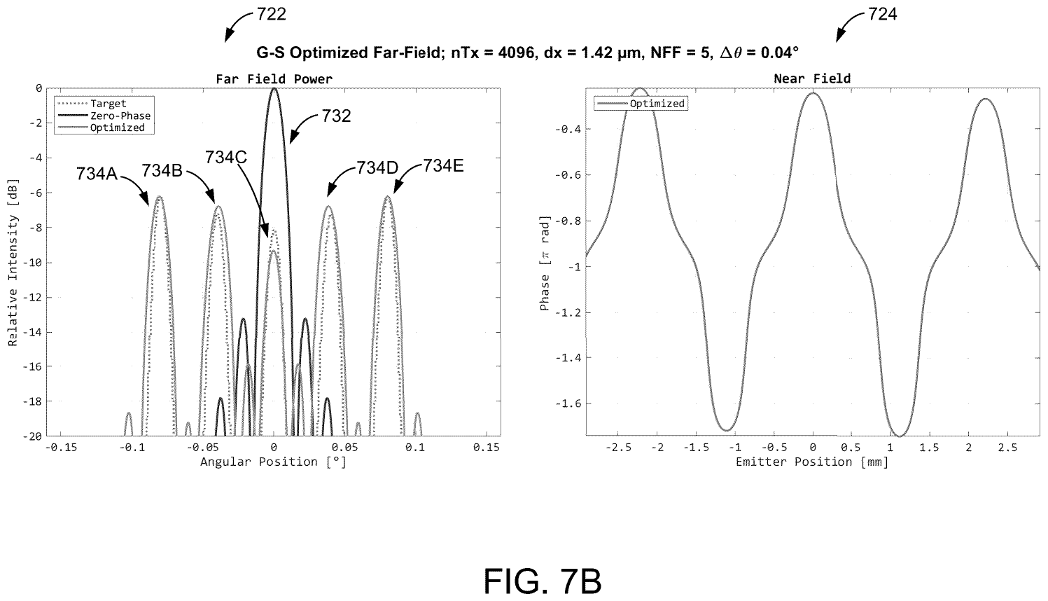

As previously described, some systems can comprise a transmit aperture that is configured to transmit, or emit, an optical beam associated with a beam pattern. In some examples, a transmit aperture can comprise an optical phased array, such as the OPA depicted in FIG. 3 or FIG. 4. Some OPAs can transmit optical beams by imprinting an appropriate phase pattern on optical antennas of the OPA. FIG. 7A depicts a plot 702 and a plot 704 of numerical simulations associated with digital beamforming. The plot 702 depicts a first beam pattern comprising an intensity peak 706 and a second beam pattern comprising a first intensity peak 708A and a second intensity peak 708B. Each of the first intensity peak 708A and the second intensity peak 708B are at a respective angular position. In this example, the second beam pattern comprises two widely spaced beams, as shown by the first intensity peak 708A and the second intensity peak 708B. The plot 704 depicts phases applied to each optical antenna of a transmit aperture, where each optical antenna is associated with an emitter position on an axis, that can produce an optical beam having the second beam pattern. Without applying the phases to the optical antennas, a transmit aperture would produce the first beam pattern comprising the intensity peak 706.

More complex applied phases can be applied to optical antennas of an optical phased array of a transmit aperture. In some examples, a phase applied to optical antennas of a transmit aperture can be represented as a continuous function rather than as discrete “steps” as shown in FIG. 7A. FIG. 7B depicts a plot 722 and a plot 724 of numerical simulations associated with digital beamforming. The plot 722 depicts a first beam pattern comprising an intensity peak 732 and a second beam pattern comprising a plurality of intensity peaks 734A-734E where each intensity peak of the plurality of intensity peaks 734A-734E is at a respective angular position. In this example, the beam pattern comprises five densely spaced beams, as shown by the intensity peak 734A, the intensity peak 734B, the intensity peak 734C, the intensity peak 734D, and the intensity peak 734E. The plot 724 depicts phases applied to each optical antenna of a transmit aperture, where each optical antenna is associated with an emitter position on an axis, that can produce an optical beam having the second beam pattern shown in the plot 722. Without applying the phases shown in the plot 724 to optical antennas of a transmit aperture, a transmit aperture would produce the first beam pattern comprising the intensity peak 732.

In some examples, a transmit aperture of a system can be configured to transmit an optical beam having a beam pattern and a receive aperture of the system can be configured to receive an optical beam having a beam pattern that corresponds to the transmitted beam pattern. Configuring a system in this way can allow the system to perform detection and ranging over several angular positions.

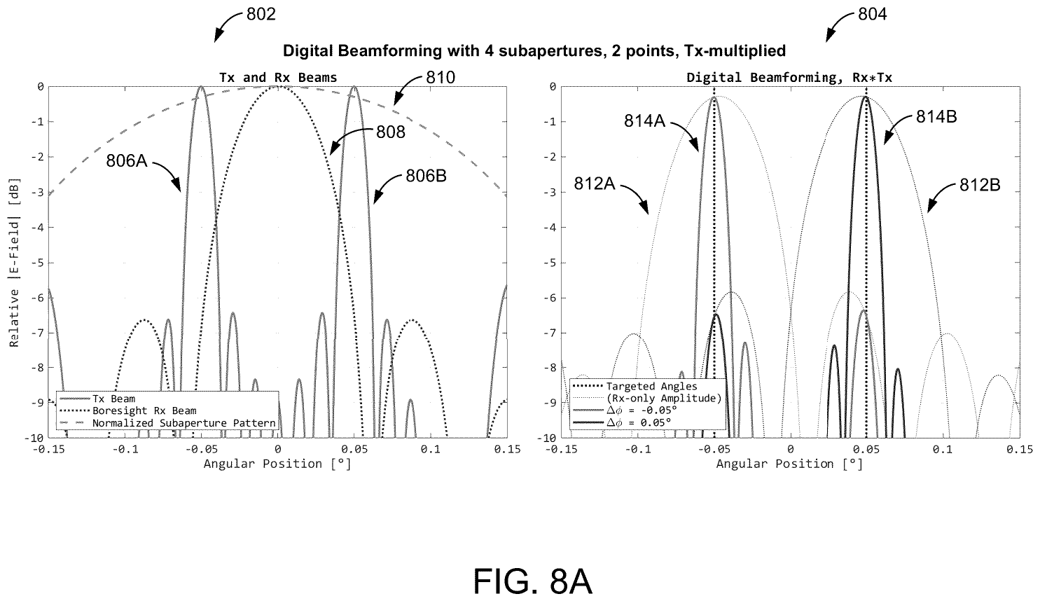

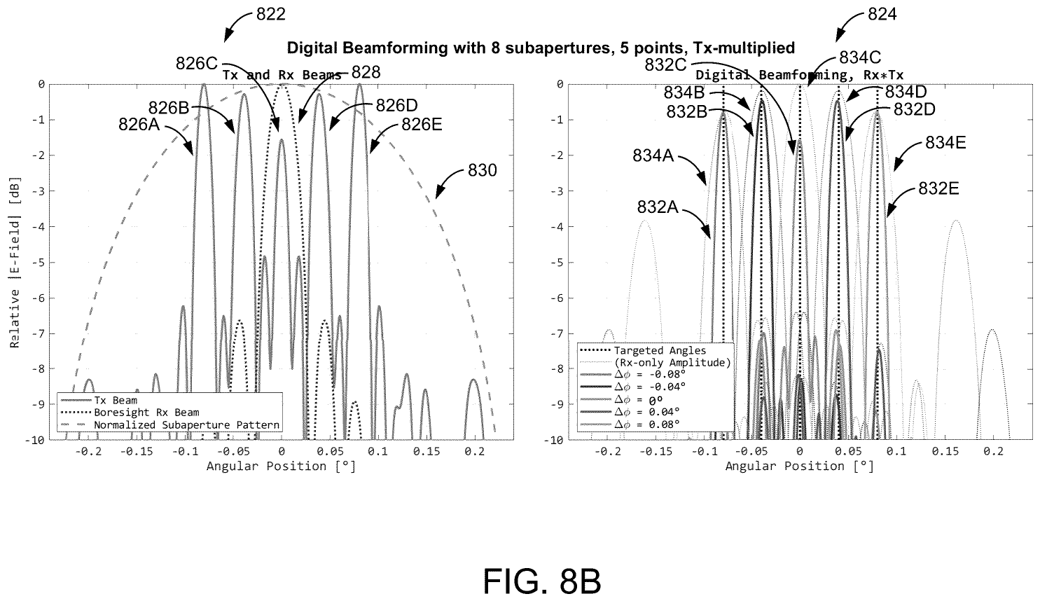

Gain associated with optical beams received at a receive aperture can be non-uniform in several directions, which can be associated with detection loss. In some implementations, the transmitted beams can be weighted such that a product of amplitudes of a transmitted optical beam and received optical beams remains uniform across points in an FoV. FIG. 8A depicts a plot 802 and a plot 804 of numerical simulations associated with configuring a beamforming system. The plot 802 depicts an example transmitted (Tx) beam comprising a beam pattern with an intensity peak 806A and an intensity peak 806B. The plot 802 further depicts an example unsteered received (Rx) beam pattern having an intensity peak 808. As shown by the plot 802, without steering a received beam pattern the overlap between a transmitted beam and a received beam can be low. By way of example, the plot 802 also depicts a beam pattern having a broad intensity peak 810 that could be detected by each sub-aperture of a receive aperture. The sub-aperture pattern can set a maximum combined Rx amplitude. The plot 804 depicts a steered Rx beam pattern comprising an intensity peak 812A and an intensity peak 812B and a total received (Tx*Rx) amplitude comprising an intensity peak 814A and an intensity peak 814B. The steered beam pattern can be achieved, for example, by four sub-apertures configured to detect two widely spaced beams, i.e., by applying the phase shifts shown in FIG. 6A. As shown in FIG. 8A, by applying phase shifts to digital signals from sub-apertures of a receive aperture to “steer” the sub-apertures, the amplitudes of reflected optical waves corresponding to two or more angular positions of a transmitted beam pattern can be determined.

FIG. 8B depicts a plot 822 and a plot 824 of numerical simulations associated with configuring a beamforming system. The plot 822 depicts an example transmitted (Tx) beam pattern comprising an intensity peak 826A, an intensity peak 826B, an intensity peak 826C, an intensity peak 826D, and an intensity peak 826E. The plot 822 also depicts an unsteered received (Rx) beam pattern comprising an intensity peak 828. The plot 822 also depicts a beam pattern comprising a broad intensity peak 830 that can be detected by each sub-aperture of a receive aperture. In some implementations, the receive aperture can comprise eight sub-apertures configured to detect five densely spaced beams, i.e., by applying the phase shifts shown in FIG. 6B. The beam pattern associated with the sub-apertures can set a maximum combined Rx amplitude. The plot 824 depicts a steered Rx pattern comprising an intensity peak 832A, an intensity peak 832B, an intensity peak 832C, an intensity peak 832D, and an intensity peak 832E. The plot 824 also depicts a total received (Tx*Rx) amplitude comprising an intensity peak 834A, an intensity peak 834B, an intensity peak 834C, an intensity peak 834D, and an intensity peak 834E.

As shown in FIGS. 8A-8B, in some examples, phase shifts applied to digital signals from a sub-aperture of a receive aperture can be applied based on the beam pattern of an optical transmitter or transmit aperture such that the receive aperture is “steered” toward the beam pattern. In other words, the phase shifts can be based at least in part on angular positions of intensity peaks of a transmitted optical beam.

Some systems, i.e., optical communication systems, can comprise optical transmitters that are configured to transmit optical waves to an optical receiver along one or more angular positions. In some examples, a system can be configured to “lock on” to an optical wave arriving along an angular position to an optical receiver. Some optical transmitters can be configured to update an angular position of a transmitted optical wave over time. In some examples, updating an angular position of a transmitted optical wave can allow for an optical transmitter to be moved in space relative to an optical receiver. Some optical receivers can be configured to continuously track an optical wave transmitted by an optical transmitter. By way of example, an optical receiver can be monitoring a beam pattern having intensity peaks at angular positions of 0°, −0.02°, and +0.02°, i.e., comparing amplitudes of optical waves corresponding to these angular positions. An optical transmitter can be transmitting optical waves to the optical receiver at the angular position +0.02° and then update to the angular position −0.02°. By configuring the optical receiver as described above, the optical receiver can continuously monitor a field-of-view and determine that the amplitude of an optical wave at the angular position −0.02° increases relative to the other angular position +0.02°. Such configurations can allow an optical communication system to decrease loss associated with re-locking the optical receiver to the transmitted optical wave by scanning the optical receiver over individual points. In some examples, a system or an optical receiver thereof can comprise circuitry that is configured to perform this tracking.

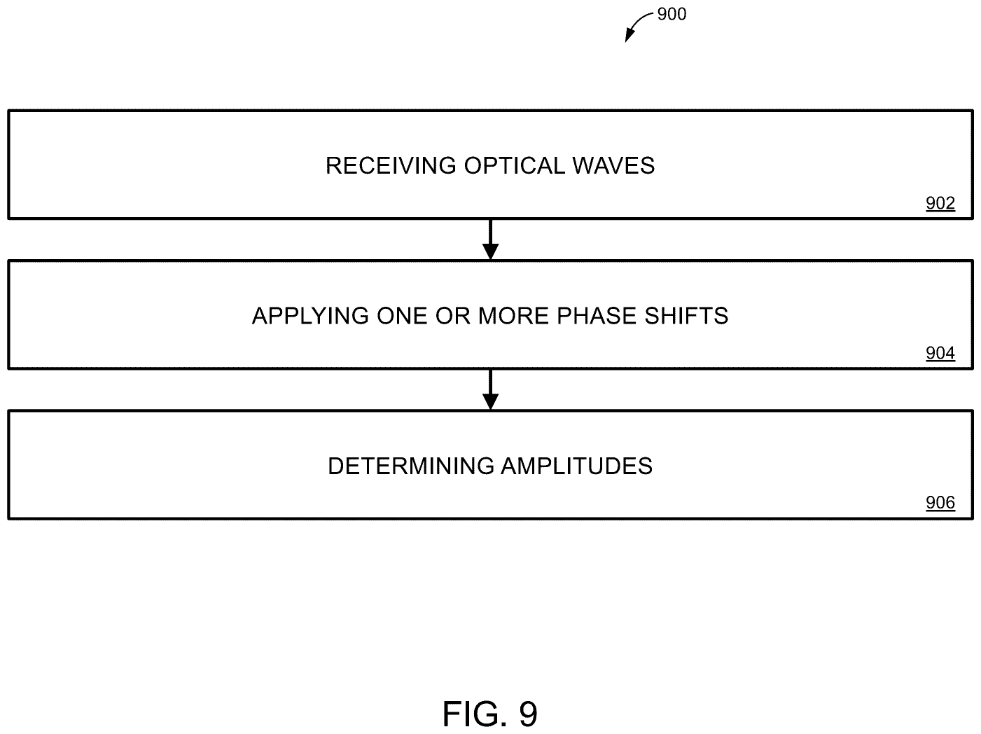

FIG. 9 depicts a flowchart of an example method 900 of using a system. The method 900 comprises receiving 900 optical waves with a receive aperture comprising a plurality of sub-apertures coupled to different respective detectors that are configured to produce respective digital signals based at least in part on the optical waves. The method 900 further comprises applying 904 one or more phase shifts to respective portions of each digital signal produced by respective detectors of two or more sub-apertures of the plurality of sub-apertures, where the one or more phase shifts are based at least in part on a first beam pattern that includes a plurality of intensity peaks at different respective angular positions. The method further comprises determining 906 respective amplitudes of received optical waves associated with two or more angular positions of the first beam pattern based at least in part on the one or more phase shifts and the respective portions of each digital signal produced by respective detectors of two or more sub-apertures of the plurality of sub-apertures.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
an optical receiver configured to receive optical waves over a receive aperture that comprises a plurality of sub-apertures coupled to different respective detectors, where each detector is configured to produce a digital signal based at least in part on a received optical wave; and
circuitry configured to
apply one or more phase shifts to a respective digital signal from each detector of the optical receiver where the one or more phase shifts are applied based at least in part on a first beam pattern that includes a plurality of intensity peaks at different respective angular positions, and
determine respective amplitudes of optical waves corresponding to two or more angular positions of the first beam pattern based at least in part on the one or more phase shifts.

2. The apparatus of claim 1, further comprising:
an optical source providing a source optical wave; and
an optical transmitter coupled to the optical source and configured to transmit an optical beam according to a second beam pattern that includes a plurality of intensity peaks at different respective angular positions;
wherein each detector of the optical receiver comprises an optical input port configured to receive a local oscillator optical wave that is coherent with the source optical wave.

3. The apparatus of claim 2, wherein each detector of a respective sub-aperture of the plurality of sub-apertures is configured to determine phase or amplitude information based at least in part on a portion of the local oscillator optical wave and a portion of an optical wave received at the respective sub-aperture.

4. The apparatus of claim 2, wherein the optical waves received by the optical receiver comprise a portion of the optical beam transmitted by the optical transmitter that is reflected by a target region.

5. The apparatus of claim 4, wherein the circuitry is further configured to perform light detection and ranging (LiDAR) on the optical waves reflected by the target region to estimate a distance to a portion of the target region.

6. The apparatus of claim 2, wherein the one or more phase shifts are based at least in part on the different respective angular positions of the plurality of intensity peaks of the optical beam.

7. The apparatus of claim 2, wherein each angular position of the first beam pattern corresponds to a respective angular position of the second beam pattern.

8. The apparatus of claim 2, wherein the circuitry is further configured to determine respective amplitudes of optical waves corresponding to each angular position of the first beam pattern.

9. The apparatus of claim 2, wherein the optical transmitter comprises an optical phased array.

10. The apparatus of claim 9, wherein the optical phased array of the optical transmitter comprises a plurality of antenna elements and a plurality of phase shifters, where each antenna element of the plurality of antenna elements is coupled to a respective phase shifter of the plurality of phase shifters.

11. The apparatus of claim 10, wherein the optical transmitter is configured to transmit the optical beam according to the second beam pattern based at least in part on phase shifts applied by each phase shifter of the plurality of phase shifters to optical waves propagating in the optical phased array.

12. The apparatus of claim 1, wherein each detector comprises an in-phase/quadrature-phase (IQ) detector.

13. The apparatus of claim 1, wherein each sub-aperture of the plurality of sub-apertures of the optical receiver comprises a respective optical phased array.

14. The apparatus of claim 13, wherein each optical phased array of the plurality of sub-apertures comprises a respective plurality of antenna elements and a respective plurality of phase shifters, where each antenna element of a respective plurality of antenna elements is coupled to a respective phase shifter of a respective plurality of antenna elements.

15. The apparatus of claim 1, wherein the optical receiver receives optical waves comprising a portion of an optical beam transmitted by an optical transmitter, where the portion of the optical beam comprises an encoded message.

16. The apparatus of claim 15, wherein the circuitry is further configured to decode the encoded message based at least in part on the optical waves received by the optical receiver.

17. The apparatus of claim 15, wherein the optical receiver is connected to a control module that is configured to decode the encoded message based at least in part on the optical waves received by the optical receiver.

18. A method comprising:
receiving optical waves with a receive aperture comprising a plurality of sub-apertures coupled to different respective detectors that are configured to produce respective digital signals based at least in part on the optical waves;
applying one or more phase shifts to respective portions of each digital signal produced by respective detectors of two or more sub-apertures of the plurality of sub-apertures, where the one or more phase shifts are based at least in part on a first beam pattern that includes a plurality of intensity peaks at different respective angular positions; and
determining respective amplitudes of received optical waves associated with two or more angular positions of the first beam pattern based at least in part on the one or more phase shifts and the respective portions of each digital signal produced by respective detectors of two or more sub-apertures of the plurality of sub-apertures.

19. The method of claim 18, further comprising transmitting an optical beam, where the optical beam is associated with a second beam pattern comprising a plurality of intensity peaks at different respective angular positions.

20. The method of claim 19, wherein the optical waves received by the receive aperture comprise a portion of the optical beam that is reflected by a target region.

21. The method of claim 19, wherein each detector comprises an optical input port configured to receive a local oscillator optical wave that is coherent with an optical wave of the optical beam.

22. The method of claim 19, wherein at least a portion of the optical beam comprises an encoded message.

23. The method of claim 22, further comprising decoding the encoded message based at least in part on the optical waves received by the receive aperture.

24. The method of claim 18, further comprising determining respective amplitudes of received optical waves associated with each angular position of the first beam pattern based at least in part on the one or more phase shifts and the respective portions of each digital signal produced by respective detectors of two or more sub-apertures of the plurality of sub-apertures.

25. The method of claim 18, wherein each detector comprises a respective in-phase/quadrature-phase (IQ) detector.

26. The method of claim 18, wherein each sub-aperture of the plurality of sub-apertures comprises a respective optical phased array.
